(19) United States
(12) Patent Application Publication
(10) Pub. No.: US 2004/0238001 A1
(43) Pub. Date: Dec. 2, 2004

(54) Carpet kicker head cover

(76) Inventor: Roger V. Risden, Naples, FL (US)

Correspondence Address: Edward M. Livingston, 963 Trail Terrace Drive, Naples, FL, 34103, US

(21) Appl. No.: 10/446,755

(22) Filed: May 28, 2003

(51) Int. Cl. A47L 25/00; B08B 7/00

(52) U.S. Cl. 134/6; 15/246; 15/247; 294/8.6; 254/200; 29/525.01; 29/426.6

(57) ABSTRACT

A cover (1) for a carpet kicker head (2) that covers the carpet kicker needles (7) on the base of the head. The cover has fastening means (8) on a distal end (17) to connect it around a needle adjustment knob (10) on the top of the kicker head and fastening means on the proximal end (16), which may include tie straps (9), snaps (19) or hook and loop fastening material (18) to secure it around a bar (4) connecting the head and a knee kicking. panel (5) on the other end, during use of the cover on the carpet kicker head to install carpet, carpet fibers (14) which become imbedded between the carpet kicker needles can be easily removed by unfastening the proximal end of the cover and pulling it in a downward direction (15), resulting in the carpet fibers being quickly and easily removed from the teeth on the base of the head, thereby eliminating the need for tedious removal by using one's fingers.

### BACKGROUND OF THE INVENTION

This invention relates to covers and more particularly a cover for the head of a carpet kicker for use in removing lint and other carpet material from between needles that accumulate on the head during use.

During carpet installation, the carpet must be stretched around the borders of a room and secured to tack strips around the perimeter of a room. A tool known as a “carpet kicker” is used to accomplish the stretching process. On one end the carpet kicker has a head containing sharp needles on a bottom surface which dig into and grip the carpet. On the other end of the carpet kicker is a padded plate connected to the head by a bar which is usually adjustable in length. As stretching is normally done in a kneeling position with the head needles embedded in the carpet, the padded bar is pushed repeatedly with the knee and/or portion of the leg just above the knee to stretch the carpet toward the perimeter of the room so that it can be secured to the tack bars. Unfortunately, with repeated use, lint and pieces of carpet material, sometimes referred to as “fuzzies”, collect on the head between the needles, which reduces the ability of the needles to grasp the carpet. The latter often results in ripping or tearing of the carpet, which may result in the entire piece of carpet needing to be replaced. Also, the slippage of the kicker due to poor grasping can result in injury to the installer when the installer falls forward on the floor or against the wall, even sometimes onto the tack strips. Currently, carpet installers must use their fingers to remove lint, which is time-consuming, very tedious and may result in injury to the fingers by cutting or pierced by the sharp needles on the head. Thus, a need exists for a device to eliminate these problems with a carpet keeper.

The prior art includes the following U.S. Pat. Nos.:

| Pat. No. | Inventor | Filing Date | Issue Date |
|---|---|---|---|
| 5,890,255 | Robinson | Jun. 19, 1995 | Apr. 06, 1999 |
| 5,600,865 | Morrison | Oct. 11, 1995 | Feb. 11, 1997 |
| 2,553,242 | Dombitsky | Jun. 18, 1946 | May 15, 1951 |
| 6,112,362 | Parko et al. | Dec. 03, 1998 | Sep. 05, 2000 |
| 6,021,542 | Norman | May 28, 1998 | Feb. 08, 2000 |
| 5,922,139 | Gilbert | Feb. 20, 1997 | Jul. 13, 1999 |
| 5,960,510 | James et al. | Jan. 08, 1997 | Oct. 05, 1999 |
| 4,517,703 | Koke | May 24, 1984 | May 21, 1985 |

None of the above patents discloses a cover device for a carpet kicker head as does the present invention.

### SUMMARY OF THE INVENTION

One object of the present invention is to provide a device to reduce the waste caused by tearing of carpet by a carpet kicker during installation of the carpet.

Another object of the present invention is to provide a device that reduces the time for carpet installation caused by having to remove carpet material from the needles of a carpet kicker head.

A further object of the present invention is to provide a device that reduces the likelihood of injury to installers associated with slippage of the head and cutting of the fingers during installation.

The present invention fulfills the above and other objects by providing a carpet kicker head cover made of flexible material and having sufficient size and shape to cover a bottom surface of the carpet kicker head. The cover has fastening means on both the distal and proximal ends thereof for removably fastening the cover around the head of the carpet kicker. The fastening means may be an elastomeric strap on the distal end to secure it around a needle extension knob on a top side of the carpet kicker head. The fastening means on the proximal end may be a pair of straps that can be tied around a connecting bar of the carpet kicker. The straps on the proximal end may also be secured together by snaps or hook and loop fastening material. The method of using the cover to remove carpeting material embedded in the needles involves unfastening the proximal end straps on the carpet kicker and then pulling down on the proximal end of the cover until the cover has been pulled away from over the needles thereby removing the carpeting material, which falls off the carpet kicker.

The above and other objects, features and advantages of the present invention should become even more readily apparent to those skilled in the art upon a reading of the following detailed description in conjunction with the drawings wherein there is shown and described illustrative embodiments of the invention.

### BRIEF DESCRIPTION OF DRAWINGS

This invention is described by appended claims in relation to a description of a preferred embodiment with reference to the following drawings which are explained briefly as follows:

FIG. 1 is a side view of the carpet kicker cover of the present invention installed on a carpet kicker;

FIG. 2 is an elevation view of the cover by itself;

FIG. 3 is an inner elevation view of the cover with the fastening means on the proximal end being tie straps;

FIG. 4 is an inner elevation view of the cover of the present invention with the straps employing snap fastening means;

FIG. 5 is an inner elevation view of the cover of the present invention with the straps employing hook and loop fastening means;

FIG. 6 is a side view of the top of the head cover showing carpet fibers embedded between the needles on the carpet kicker head after use; and

FIG. 7 is a side view showing the cover being used to remove carpeting material embedded between the needles of a carpet kicker head.

### DESCRIPTION OF PREFERRED EMBODIMENT

Listed numerically below with reference to the drawings are terms used to describe features of this invention. These terms and numbers assigned to them designate the same features throughout this description.

1. Cover

2. Head

3. Carpet kicker

4. Adjustable bar

5. Knee pad

6. Kicker plate

7. Head needles

8. Distal end straps

9. Hinge

10. Handle

11. Strap eyelets

13. Inside of cover

14. Carpet fiber

15. Cover removal direction

16. Proximal end of cover

17. Distal end of cover

18. Matching hook and loop fasteners

19. Snaps

Referring to the drawings, in FIG. 1 a carpet kicker 3 is shown generally having a head 2 at one end with needles protruding 7 from a bottom surface. On the opposite end of the carpet kicker is a plate 6 with knee pad 5 connected to the head 2 by a connecting bar 4 which may be adjustable in length. The cover 1 is shown secured over the needles 7 to the head secured at a distal end 17 by an elastomeric strap 8 placed around the needle extension knob 10 on a top surface of the kicker head 2. The proximal end 16 of the cover has removable fastening means 9 which may consist of tie straps as illustrated.

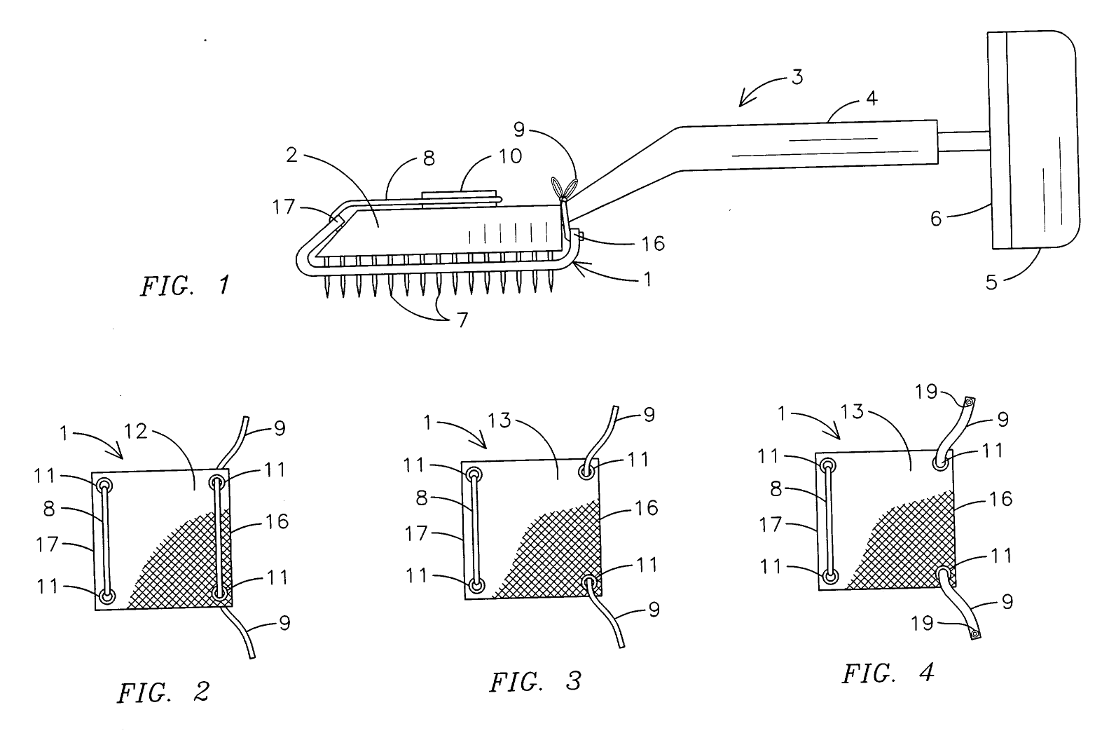

In FIG. 2 the cover 1 is illustrated showing the outside surface 12 having eyelets 11 in each corner of the cover for securing fastening straps. The cover would preferably be made of cloth which may be slightly elastomeric, such material as nylon, spandex or similar elastomeric material, so that it stretches over various sized kicker heads.

In FIG. 3 the cover 1 is shown from the inner side having an elastomeric strap 8 placed through the eyelets 11 on a distal end 17 which is stretchable to fit around the needle extension knob 10. On the proximal end tie straps 9 are shown in place on the eyelets 11 on the proximal end of the cover.

FIG. 4 shows the same cover except that the proximal straps 9 use snaps 19 to secure the snaps together around the connecting bar 4 of the carpet kicker.

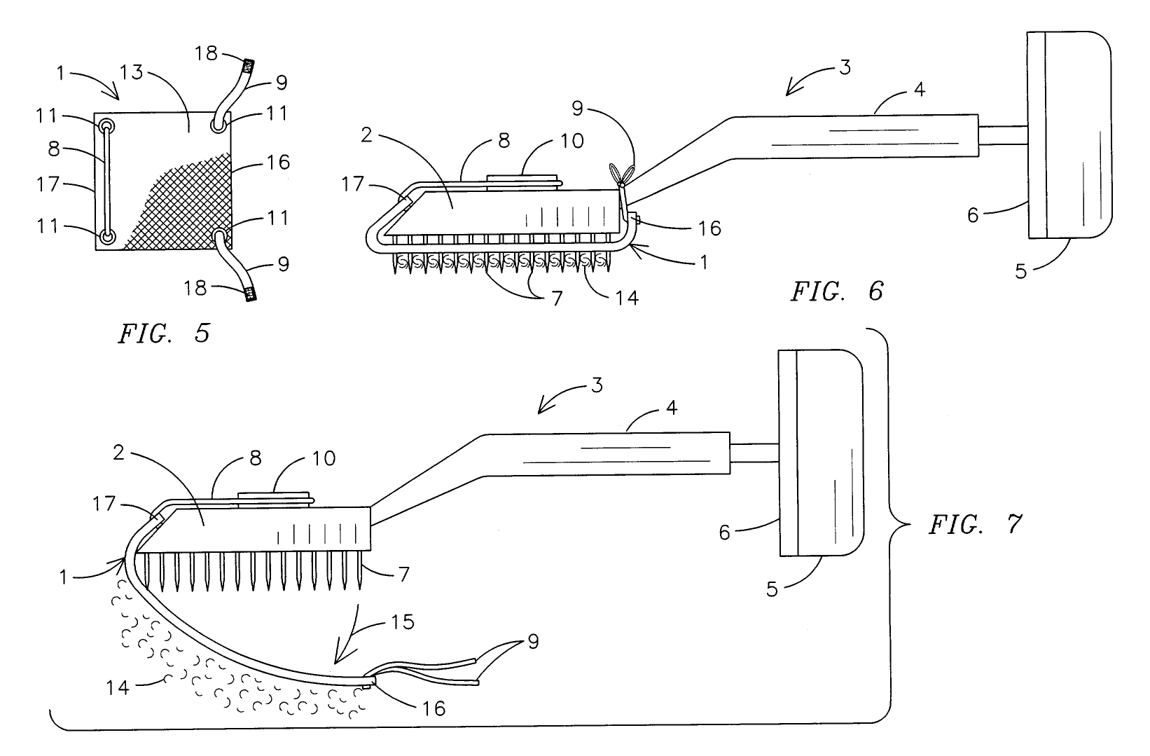

FIG. 5 shows the use of matching hook and loop fastening material to secure the proximal straps 9 around the kicker head.

Finally, FIG. 6 shows the top of the kicker head with cover installed is shown after the kicker has been used to stretch carpet, with the result being extensive carpet fibers 14, sometimes called “fuzzies” in the trade, imbedded in the needles 7 which reduces the grasping ability of the needles 7, often to the point that the carpet is torn or ripped.

FIG. 7 shows the use of the cover of the present invention to easily, quickly and safely remove the carpet material 14 by unfastening the straps 9 from around the connecting rod 4 and pulling the cover in the direction of the arrow 15 so that the bottom of the cover comes off the needles thereby removing the carpet fibers 14.

The use of the cover of the present invention avoids the need to use fingers or brushes to remove the fibers embedded in the needles 7. After removal of the carpet fibers 14 the proximal end of the cover can be re-fastened around the connecting bar 4 by securing the straps around the connecting bar. The fastening straps could even be sewn into the circumference of the cover.

A new and useful carpet head cover having been described, all such foreseeable modifications, adaptations, substitutions of equivalents, mathematical possibilities or combinations of parts, pluralities of parts, applications and forms thereof as described by the following claims and not precluded by prior art are included in this invention.

Having thus described my invention, I claim:

1. A carpet kicker head cover comprising:
a flexible piece of material having sufficient size and shape to cover a bottom surface of a carpet kicker head, said cover having a distal and a proximal end; and
fastening means at both the distal end and the proximal end for removably fastening the cover around the bottom surface over needles of the carpet kicker head.

2. The carpet kicker head cover of claim 1 wherein the fastening means on the distal end comprises an elastomeric strap that is secured around a needle extension knob on a top surface of the carpet kicker head.

3. The carpet kicker head cover of claim 1 wherein the fastening means on the proximal end comprises a pair of straps for removably tying the cover around a connecting bar on the proximal end of the head.

4. The carpet kicker head cover of claim 2 wherein the fastening means on the proximal end comprises a pair of straps for removably tying the cover around a connecting bar on the proximal end of the head.

5. The carpet kicker head cover of claim 1 wherein the fastening means on the proximal end comprises a pair of straps with snap fasteners on each end for securing the straps around a connecting bar on the proximal end of the head.

6. The carpet kicker head cover of claim 2 wherein the fastening means on the proximal end comprises a pair of straps with snap fasteners on each end for securing the straps around a connecting rod on the proximal end of the head.

7. The carpet kicker head cover of claim 1 wherein the fastening straps on the proximal end comprises a pair of straps having hook and loop fasteners.

8. The carpet kicker head cover of claim 2 wherein the fastening straps on the proximal end comprises a pair of straps having hook and loop fasteners.

9. The carpet kicker head cover of claim 1 wherein the flexible piece of material is a cloth having elastomeric equalities.

10. A method of removing carpet fibers imbedded in needles on a bottom surface of a carpet kicker head during carpet installation using a cover comprising a flexible piece of material having sufficient size and shape to cover a bottom surface of a carpet kicker head, wherein the fastening means on the distal end comprises an elastomeric strap secured around a needle extension knob on a top side of a carpet kicker head and straps on the proximal end, said method comprising the steps of:
placing the cover over the needles of a bottom surface of the head by fastening the distal straps around the needle extension knob on the top of the head and fastening the proximal straps around the connecting bar of the carpet kicker; and
after carpet fibers have become imbedded between the needles, unfastening the proximal straps and removing the cover downward until it is off the needles and the carpet fibers are removed.
